(19) United States
(12) Patent Application Publication
(10) Pub. No.: US 2015/0029904 A1
(43) Pub. Date: Jan. 29, 2015

(54) ENABLING FULL-DUPLEX COMMUNICATION IN LEGACY LTE SYSTEMS

(71) Applicant: NEC Laboratories America, Inc., Princeton, NJ (US)

(72) Inventors: Mohammad Khojastepour, Lawrenceville, NJ (US); Karthikeyan Sundaresan, Howell, NJ (US); Sampath Rangarajan, Bridgewater, NJ (US)

(21) Appl. No.: 14/334,129

(22) Filed: Jul. 17, 2014

Related U.S. Application Data
(60) Provisional application No. 61/859,232, filed on Jul. 27, 2013.

(51) Int. Cl. H04L 5/16

(52) U.S. Cl. CPC H04L 5/16
USPC 370/277

(57) ABSTRACT

Methods are provided for converting from half-duplex communication to full-duplex communication in a legacy wireless cellular system having a base station. A method includes providing in the base station separate transmit and receive paths for transmit signals and receive signals, respectively. The method further includes converting an uplink frequency band and a downlink frequency band for the base station to a same frequency band. The method also includes applying analog signal cancellation techniques at the base station to isolate a full-duplex wireless reception signal from a full-duplex wireless transmission signal.

### RELATED APPLICATION INFORMATION

This application claims priority to provisional application Ser. No. 61/859,232 filed on Jul. 27, 2013, incorporated herein by reference.

### BACKGROUND

1. Technical Field

The present invention relates to signal processing, and more particularly to enabling full-duplex communication in legacy long term evolution (LTE) systems.

2. Description of the Related Art

With the growing demand for increased spectral efficiencies in wireless networks, there has been renewed interest in enabling full-duplex communications. However, existing approaches to enable full-duplex involve both analog and digital cancellation techniques and hence a clean-slate approach to address the key challenge in full-duplex, namely self-interference (SI) suppression. This serves as a big deterrent to enabling full-duplex in legacy cellular networks,

### SUMMARY

These and other drawbacks and disadvantages of the prior art are addressed by the present principles, which are directed to enabling full-duplex communication in legacy long term evolution (LTE) systems.

According to an aspect of the present principles, a method is provided for converting from half-duplex communication to full-duplex communication in a legacy wireless cellular system having a base station. The method includes providing in the base station separate transmit and receive paths for transmit signals and receive signals, respectively. The method further includes converting an uplink frequency band and a downlink frequency band for the base station to a same frequency band. The method also includes applying analog signal cancellation techniques at the base station to isolate a full-duplex wireless reception signal from a full-duplex wireless transmission signal.

According to another aspect of the present principles, a method is provided for converting from half-duplex communication to full-duplex communication in a wireless cellular system having a base station with an antenna port. The method includes enabling transmit and receive communications on a same band on the antenna port of the base station. The method further includes providing in the base station separate transmit and receive paths for the full-duplex communication. The method also includes applying analog signal cancellation techniques at the base station to isolate the transmit communications from the receive communications.

According to yet another aspect of the present principles, a method is provided for converting half-duplex communications to full-duplex communications. The method includes providing a first legacy base station and a second legacy base station. Each of the base stations is configured to use a same uplink frequency band and a same downlink frequency band for the half-duplex communications. The method further includes switching the uplink frequency band with the downlink frequency band for only one of the base stations to provide the full-duplex communications for client devices interconnected through the base stations.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary wireless communication system 100 to which the present principles can be applied, in accordance with an embodiment of the present principle;

FIG. 2 further shows the evolved packet core (EPC) 190 of FIG. 1, in accordance with an embodiment of the present principles;

FIG. 3 further shows the client 180 of FIG. 1, in accordance with an embodiment of the present principles; and

FIG. 4 shows an exemplary method 400 for converting from half-duplex communication to full-duplex communication in a legacy wireless communication system having a base station, in accordance with an embodiment of the present principles.

### DETAILED DESCRIPTION OF PREFERRED EMBODIMENTS

The present principles are directed to enabling full-duplex communication in legacy long term evolution (LTE) communication systems. A full-duplex (FD) communication system uses a single band and simultaneously has both downlink and uplink transmissions on this band.

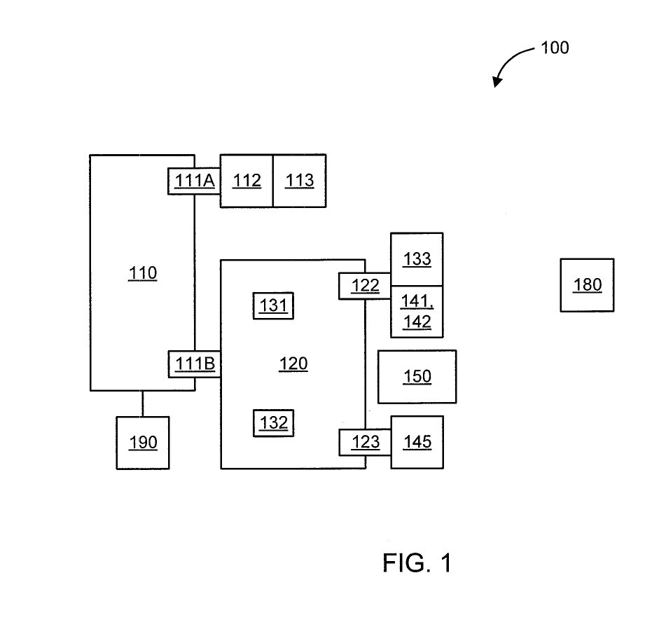

FIG. 1 shows an exemplary wireless communication system 100 to which the present principles can be applied, in accordance with an embodiment of the present principles. The wireless system 100 includes a legacy base station 110 initially configured for half-duplex communication. As shown in FIG. 1, the base station 110 is converted to full-duplex communication in accordance with the present principles.

The wireless system 100 further includes one or more client devices 180 for communicating with the base station 110. The wireless system also includes a evolved packet core 190 for supporting Internet connectivity for the client devices 180 as well as various management functions for the mobile operators.

The base station 110 includes two antenna ports 111A and 111B for multiple input multiple output (MIMO) operation. Since the present principles are directed to providing full-duplex operation with legacy base stations, in an embodiment, one of the antenna ports 111A is connected to an attenuator 112 and a terminator 113. The other antenna port 111B is connected to a frequency converter 120 having a transmit antenna port 122 and a receive antenna port 123. The frequency converter 120 includes a circulator 131 and frequency converter circuits 132. An antenna cancellation circuit 133 is connected to the transmit antenna port 122. The antenna cancellation circuit 133 can include a phase shifter. A first transmit antenna 141 is connected to the transmit antenna port 122. In an embodiment, a second transmit antenna 142 is also connected to the transmit antenna port 122, to thus provide a transmit antenna pair 141, 142. A receive antenna 145 is connected to the receive antenna port 123. A radio frequency (RF) shield/absorber 150 is placed between the receive antenna 145 and the transmit antenna(s) 141 (142). The RF shield/absorber 150 is one exemplary type of self-interference (SI) suppression technique employed in accordance with the present principles. Other types of SI suppression techniques that can be used in accordance with the present principles include, but are not limited to, antenna separate, antenna cancellation, antenna polarization, and antenna directionality.

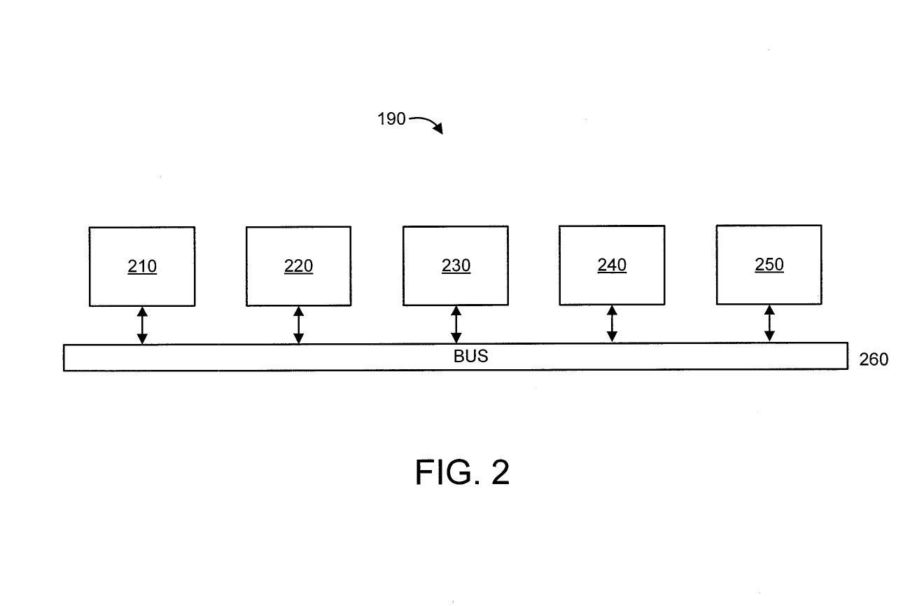

FIG. 2 further shows the evolved packet core (EPC) 190 of FIG. 1, in accordance with an embodiment of the present principles. The EPC 190 includes a mobile management entity (MME) 210, a home subscriber server (HSS) 220, a policy and charging rules function (PCRF) 230, a serving gateway 240, and an Internet gateway 250, all interconnected via a bus 260. The MME 210 is for session and subscriber management. The HSS 220 is for storing user profile information. The PCRF 230 is for managing a service policy and configuring quality of service parameters.

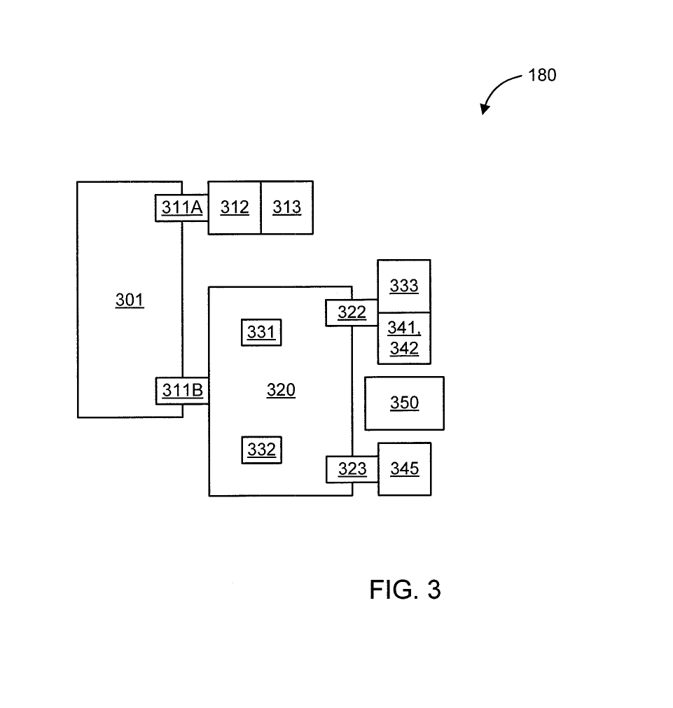

FIG. 3 further shows the client 180 of FIG. 1, in accordance with an embodiment of the present principles. In an embodiment, the client 180 is a universal serial bus (USB) dongle. The client 180, as configured in accordance with the teachings of the present principles, includes a wireless interface 301, a frequency converter 320, a receive antenna 345, a transmit antenna 341 or transmit antenna pair 341, 342, and an RF shield/absorber 350.

The wireless interface 301 includes two antenna ports 311A and 311B for multiple input multiple output (MIMO) operation. In an embodiment, one of the antenna ports 311A is connected to an attenuator 312 and a terminator 313. The other antenna port 311B is connected to a frequency converter 320 having a transmit antenna port 322 and a receive antenna port 323. The frequency converter 320 includes a circulator 331 and frequency converter circuits 332. An antenna cancellation circuit 333 is connected to the transmit antenna port 322. The antenna cancellation circuit 333 can include a phase shifter. A first transmit antenna 341 is connected to the transmit antenna port 322. In an embodiment, a second transmit antenna 342 is also connected to the transmit antenna port 322, to thus provide a transmit antenna pair 341, 342. A receive antenna 345 is connected to the receive antenna port 323. A radio frequency (RF) shield/absorber 350 is placed between the receive antenna 345 and the transmit antenna(s) 341 (342).

The antenna port of the client is connected to the frequency converters 320 similar to the base station of FIG. 1 to isolate the transmit and receive signal paths as well as convert the frequency bands of the uplink and downlink transmissions to a single band. The only difference is that frequency synthesizers used in the transmit and receive paths in the user equipment (UE) frequency converter side are swapped compared to those used on the base station side. Once again, the transmit antenna port 322 of the frequency converter 320 is connected to a transmit antenna cancellation circuit 333 and the transmit antennas 341, 342 and receive antenna 345 are further isolated using the RF shield/absorber 350.

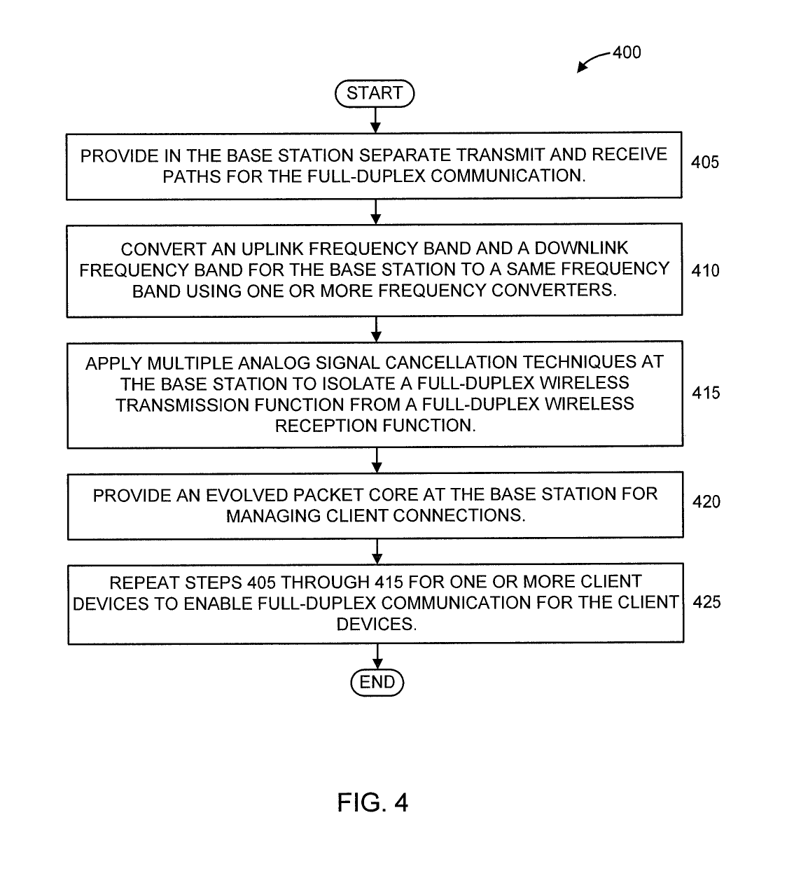

FIG. 4 shows an exemplary method 400 for converting from half-duplex communication to full-duplex communication in a legacy wireless communication system having a base station, in accordance with an embodiment of the present principles.

At step 405, provide in the base station separate transmit and receive paths for the full-duplex communication.

At step 410, convert an uplink frequency band and a downlink frequency band for the base station to a same frequency band using one or more frequency converters.

At step 415, apply multiple analog signal cancellation techniques at the base station to isolate a full-duplex wireless transmission function from a full-duplex wireless reception function. The analog signal cancellation techniques can include, but are not limited to, antenna cancellation, radio frequency shielding, antenna polarization, and antenna directionality.

At step 420, provide an evolved packet core at the base station for managing client connections.

At step 425, repeat steps 405 through 415 for one or more mobile client devices to enable full-duplex communication on the mobile client devices. It is to be appreciated that steps 405 through 415 are essentially the same for the client devices except that the frequency synthesizers used in the transmit and receive signal paths in the user equipment frequency converter side are swapped compared to those used on the base station side.

Further details regarding the steps of method 400 are provided in the attached appendix.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. Additional information is provided in an appendix to the application entitled, “Additional Information”. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method for converting from half-duplex communication to full-duplex communication in a legacy wireless cellular system having a base station, the method comprising:
providing in the base station separate transmit and receive paths for transmit signals and receive signals, respectively;
converting an uplink frequency band and a downlink frequency band for the base station to a same frequency band; and
applying analog signal cancellation techniques at the base station to isolate a full-duplex wireless reception signal from a full-duplex wireless transmission signal.

2. The method of claim 1, further comprising providing an evolved packet core connected to the base station for managing client connections.

3. The method of claim 2, wherein the evolved packet core is provided to include a mobility management entity for session and subscriber management, a home subscriber server for storing user profile information, and a policy and charging rules function for managing a service policy.

4. The method of claim 1, wherein the base station includes an antenna port, and the method further includes separating transmit and receive paths of the antenna port using a circulator and one or more bandpass filters.

5. The method of claim 4, further comprising:
connecting at least one receive antenna to the receive path of the antenna port;
connecting at least one pair of transmit antennas to the transmit path of the antenna port;
arranging the at least one pair of transmit antennas to be equidistant from the at least one receive antenna; and
connecting a phase shifter to at least one of the transmit antennas to nullify a self-interference signal.

6. The method of claim 4, further comprising:
connecting at least one transmit antenna to the transmit path of the antenna port;
connecting at least one pair of receive antennas to the receive path of the antenna port;
arranging the at least one pair of receive antennas to be equidistant from the at least one transmit antenna; and
connecting a phase shifter to at least one of the receive antennas to nullify a self-interference signal.

7. The method of claim 1, wherein the analog signal cancellation techniques comprise applying radio frequency shielding between at least one receive antenna and at least one transmit antenna respectively connected to the receive and transmit paths.

8. The method of claim 1, wherein the analog signal cancellation techniques comprise antenna directionality or antenna polarization.

9. The method of claim 1, further comprising transparently switching to the half-duplex communication to communicate with half-duplex client devices.

10. The method of claim 1, wherein the analog signal cancellation techniques comprise passive interference cancellation techniques.

11. The method of claim 1, further comprising configuring a mobile client to have the full-duplex communication, wherein said configuring step comprises
providing in the mobile client separate transmit and receive paths for the full-duplex communication;
converting the uplink frequency band and the downlink frequency band for the mobile client to the same frequency band; and
applying an analog signal cancellation technique at the mobile client to isolate the full-duplex wireless transmission function from the full-duplex wireless reception function.

12. A method for converting from half-duplex communication to full-duplex communication in a wireless cellular system having a base station with an antenna port, the method comprising:
enabling transmit and receive communications on a same band on the antenna port of the base station;
providing in the base station separate transmit and receive paths for the full-duplex communication; and
applying analog signal cancellation techniques at the base station to isolate the transmit communications from the receive communications.

13. The method of claim 12, further comprising providing an evolved packet core connected to the base station for managing client connections.

14. The method of claim 13, wherein the evolved packet core is provided to include a mobility management entity for session and subscriber management, a home subscriber server for storing user profile information, and a policy and charging rules function for managing a service policy.

15. The method of claim 12, further comprising:
connecting at least one receive antenna to the receive path;
connecting at least one pair of transmit antennas to the transmit path;
arranging the at least one pair of transmit antennas to be equidistant from the at least one receive antenna; and
connecting a phase shifter to at least one of the transmit antennas to nullify a self-interference signal.

16. The method of claim 12, further comprising:
connecting at least one transmit antenna to the transmit path;
connecting at least one pair of receive antennas to the receive path;
arranging the at least one pair of receive antennas to be equidistant from the at least one transmit antenna; and
connecting a phase shifter to at least one of the receive antennas to nullify a self-interference signal.

17. The method of claim 12, wherein the analog signal cancellation techniques comprise applying radio frequency shielding between at least one receive antenna and at least one transmit antenna respectively connected to the receive and transmit paths.

18. The method of claim 12, wherein the analog signal cancellation techniques comprise antenna directionality or antenna polarization.

19. A method for converting half-duplex communications to full-duplex communications, comprising:
providing a first legacy base station and a second legacy base station, each configured to use a same uplink frequency band and a same downlink frequency band for the half-duplex communications; and
switching the uplink frequency band with the downlink frequency band for only one of the base stations to provide the full-duplex communications for client devices interconnected through the base stations.

20. The method of claim 19, further comprising applying an interference cancellation technique to cancel a downlink interference from the first base station response to an uplink reception by the second base station.
